(19) United States
(12) Patent Application Publication
(10) Pub. No.: US 2002/0156779 A1
(43) Pub. Date: Oct. 24, 2002

(54) Internet search engine

(76) Inventors: Margaret E. Elliott, Ojai, CA (US); David W. Bell, Pine Mountain Club, CA (US); James E. Welch, Santa Barbara, CA (US)

Correspondence Address: RALPH D CHABOT, 2310 E PONDEROSA DR, SUITE 4, CAMARILLO, CA, 93010, US

(21) Appl. No.: 09/937,789

(22) PCT Filed: Feb. 16, 2001
(86) PCT No.: PCT/US01/05165

(51) Int. Cl. G06F 7/00

(52) U.S. Cl. 707/6

(57) ABSTRACT

The invention disclosed is a spatial indexing intelligent agent that indexes information against a database of spatial language which is used in combination with a modified search engine that conducts searches using spatially relevant criteria and spatial analysis algorithms Alpha-numeric values from a mathematical system are used for identifying spatial locations, and can be arbitrary, geocentric, virtual, and galactic.

This application claims priority to U.S. provisional application filed Jan. 10, 2001 bearing serial No. 60/261095, to U.S. provisional application filed Aug. 18, 2000 bearing serial No. 60/226358 and to U.S. provisional application filed Feb. 28, 2000 bearing serial No. 60/185,322.

### TECHNICAL FIELD

Our invention relates to search engines for locating, identifying, indexing and retrieval of desired information from the Internet. Two primary applications are disclosed which are each integral parts to the overall invention..

The first is a spatial indexing intelligent agent which is a hybrid between Web-Indexing Robots and Spatial Robot Software (SRS) that indexes information against a database of spatial language.

The second is a modified search engine which is a hybrid between Internet Search Engines and Spatial Search Engines that conducts searches using spatially relevant criteria and spatial analysis algorithms.

### BACKGROUND ART

### Part I: Web Indexing Robots

Web roaming applications (or ‘spiders’, or ‘robots’) use the link information embedded in hypertext documents to locate, retrieve, and locally scan as many documents as possible for keywords entered by the reader. Embedded link information in each document, facilitates a greater scope of search since available hypertext documents are likely to be searched. However, since links are embedded only when the destination is believed to exist, links to very new documents may not yet exist and the new information may be able to be located. Further, it is possible that whole sections of the hypertext may not have been searched by a spider because, for example, a server holding desired information was unreachable due to a network or server downtime.

For purposes of this application, the term “input words” is defined as consisting of letters only and exclude digits and punctuation. Before input words are inserted into an index which is being generated, they are configured in lower case, and reduced to a canonical stem by removal of suffixes.

For purposes of this application, the terms “noise words”, or “stop words” are defined as common words such as: “the”, “and”, “or”.

Before input words are inserted into an index, they are first compared against lists of noise words which are part of the spider software. Input text words are compared exactly against the noise words. The input word is ignored if a match occurs. Thus common invariant words, can be kept out of the index; effectively reducing the size of the generated index.

A robot can be programmed which sites to visit by using varied strategies. In general, robots start from a historical list of URLS, especially documents having many links elsewhere, such as server lists, “What's New” pages, and the most popular sites on the Web. Most indexing services also allow server administrators to submit URLs manually, which will then be queued and visited by the robot. Sometimes other sources for URLs are used, such as scanners through USENET postings, published mailing list archives, etc. Provided with such starting points, a robot can select URLs to visit and index, and parse and use the starting point as a source for new URLs. Robots decide what to index. When a document is located, it may decide to parse it, and insert it into its database. How this is done depends on the robot: Some robots index the HTML Titles, or the first few paragraphs, or parse the entire HTML and index all words. Weighing the significance of each document can depend on parameters such as HTML constructs, etc. Some robots are programmed to parse the META tag, or other special hidden tags contained within each document.

### Part II: Spatial Robot Software (SRS)

Existing SRS correlate text found in “spidered” data against an address database which usually contains postal addresses and/or area codes. SRS applications presently do not index Internet content by traversing the hyperlinks in the manner of web indexing robots. Present SRS only reviews the results obtained by the web indexing robots. Specifically, SRS seek occurrences of addresses in the data records. SRS also qualifies indexed data and will score the confidence that the content is about the address in the database and is not an off topic mentioned. Other software will utilize the scores to filter results which do not meet a specific confidence threshold, thereby presenting only the most relevant results to a requester.

### Part III: Internet Search Engine Technology

The state of the art for search engines is to follow a simple iterative process of narrowing down a large number of possible sites for a given query and returning those that survive the filtering process. Typically, all searches begin with an index of Web pages. Indexes typically contain words found on millions of Web pages, and are constantly updated by removing dead links and adding new pages. The goal is to create an index of the entire World Wide Web.

A scoring system is used to sort through that index and find the pages the client seems to want. Search engines combine many different factors to find the best matches, including text relevance and link analysis. Text relevance searches every Web page for exactly the words entered. Many factors enter into text relevance, such as how important the words are on the page, how many times the words appear where on the page they appear, and how many other pages contain those words. Multiple words can be entered through the search interface usually utilizing some form of Boolean logic (AND, OR, and NOT filters). Link analysis uses the many connections from one page to another to rank the quality and/or usefulness of each page. In other words, if many Web pages are linking to a page X, then page X is considered a high-quality page.

The search engine checks the word index and correlates it with web site data found in a database. The database of web sites will contain basic information gleaned from the web site by a web-indexing robot. The robot will pull descriptions and keywords from meta tags inserted by the author of the page in accordance with HTML specifications from the World Wide Web Consortium (W3C). Different robots will collect different additional information and perform some analysis on the page in an attempt to capture better information about the sites checked by the robot. This information will fuel the text and link analysis performed by the search engine.

Search engines use the filtering results performed by the web indexing robot to enhance their search capabilities and to perform on-demand filtering based on client input at the time of the search.

### Part IV: Spatial Search Engine (SSE)

An Internet search engine searches an index of words collected by web indexing robots. A SSE searches the spatial index to that index of words or the spatial columns of data in that index of words to find matches in a radius distance from a geographic coordinate. The input may be either a postal address or postal address fragment. First, the search engine resolves the user input to a geographic coordinate, next it uses that coordinate in its search of the word index or spatial index.

### DISCLOSURE OF INVENTION

In accordance with the present invention, a spatial indexing intelligent agent for indexing spatial information and a spatial search engine are disclosed.

### Definitions

The following are definitions of key phrases used in this disclosure:

“Attribute information”—descriptive information about a spatial location which can include but is not limited to: demographic information, historical facts, economic information, alternative names (“Windy City” for Chicago, or “Beantown” for Boston) and feature type (is location a cemetery, park, landmark, etc.).

“Coordinate information”—alpha-numeric values from a mathematical system for identifing spatial locations, and can be arbitrary, geocentric, virtual, and galactic.

“Identifier information”—information that uniquely identifies/describes spatial locations which are part of the spatial lexicography database, and can be, but not limited to such items as area code, cellular signature, place name, and zip code.

“Spatial lexicography database”—a database which contains spatial information; specifically: 1) coordinate information; and, 2) Identifier information in such a way that it associates spatial locations in the coordinate system with different identifier types such as a city name, county, state, area code, zip code, etc. This database may also contain: 3) Attribute information. This database contrasts different identifier codes to one another such as Near/Far; Above/Below; Contains.

“Spatial information”—information related to or about locations in three-dimensional space. Spatial information includes identifier information and attribute information. Examples of spatial information include: postal zip codes, area codes, geographic longitude/latitude coordinates, and place names. Besides two-coordinate systems, spatial information can also be extended to include three dimensional models so that the height above or below a two dimensional coordinate can also be considered

“Topical database”—Organized collection of information. Can include spatial information and non-spatial information.

### SUMMARY OF INVENTION

The spatial search engine contains a spatial lexicography database. This database encompasses all locations and defines the searchable universe or realm. The spatial lexicography database comprises two separate types of information but information which is associated with one another. The first is coordinate information which is used to identify every location in the searchable universe. The second type of information is termed identifier information and is information which is associated or identified with any of said locations in the searchable universe.

A second database, separate from the spatial lexicography database, contains documents indexed by a spatial indexing intelligent agent or spider. How the spider searches for documents will be discussed later.

Having both databases, a requester would provide search criteria which is necessary to conduct the search. The search criteria comprises a reference location and a search radius about the reference location.

The search engine would convert the entered reference location into a three dimensional coordinate and then, using a mathematical algorithm convert the search radius into either a two or three dimensional coordinate box surrounding said reference coordinate. This coordinate box sets the outerboundary for selecting identifier information. The choice of two or three dimensional coordinates depends upon the nature of the searchable universe. If the universe is simply geographic, then it may be only two dimensional while a galactic or virtual coordinate system would be three dimensional.

The search engine next searches the spatial lexicography database and selects all identifier information which is within the coordinate box.

Finally, a comparison is made of the spidered spatial information of the second database against the selected identifier information of the spatial lexicography database. Information present in both databases is considered a match which identifies spatially relevant information queried by the requestor.

### Access Phase

The Agent will utilize two database sources prior to indexing any information. It does not matter which database source is first used so long as both are utilized prior to the indexing phase. One database contains Universal Resource Identifier (URI) addresses. The size of this database will change as the spider identifies and adds new URI's to the database and removes URI's where no resource is found.

The other database is the spatial lexicography database which contains spatial locations, demographic information and place names. This database can be initially formed from various sources of public information such as census, and gazetteer data. Attribute information can be added to the spatial lexicography database, such as genealogical data pertaining to such places as cemeteries, and surnames; archaeological information; historical society data such as war memorials, and sites of historical significance; geological society information such as locations of geysers, caves, etc.; national park information; commercial source information such as the location for campgrounds, retail centers, marinas, etc.; other governmental information such as airport locations, military bases, and other government offices; educational information such as locations for schools and universities; and astronomical data like celestial locations such as the location of a star or the specific crater on the moon. Other spatial locations can include those for fictional sites such as those which are part of computer games and use of an arbitrary grid reference system such as is used for the architecture/engineering industry. These sources are only examples of what can be included into a spatial lexicography database and are not limited to only the aforementioned examples.

Typically, the spatial indexing agent/spider is parse various URI's seeking spatial reference. For example, a URI may identify a document which contains a number of spatial references, such as Washington, D.C., the United States Patent Office, and Dulles Airport. This URI will be scored against the identified spatial references so that a confidence is obtained for each spatial reference that the document is about that spatial reference.

The actual operation of the spatial indexing agent/spider is to parse the resource obtained at a URI residing in the URI database. The spider also reads the spatial lexicography database and stores it in RAM. Collectively, we refer to this portion as the Access Phase.

### Parsing Phase

In the next phase, termed the Parsing Phase, the spider then formulates a search pattern to filter the information contained in the spatial lexicography database to only the data which has a match to the URI reference. The search pattern is essentially a multiple filtering process.

By way of example, assume a webpage for a golf course development company has been retrieved by the spider. The spider would be programmed to search the webpage for occurrences of state names and/or their variations. A copy of all spatial information pertaining to any state names identified is created within the spider. This is the first stage of the filtering process and reduces the reviewable spatial lexicography database down to only the spatial information which is identified for those particular states. The second stage of the filtering process then takes the URI referenced document and compares it to the features remaining in the spatial lexicography database for those particular states. The features can include such items as the city name, airport, retail center, park, marina, etc. as were discussed above. Any features present in the spatial lexicography database which are present in the URI referenced document will be flagged or identified The identified features and the URI referenced document will next proceed to the Scoring Phase.

If no features are identified, the Scoring Phase is bypassed, and the URI referenced document proceeds to the Archive Phase wherein it will be recorded that it is non-spatial. The purpose behind recording URI's which do not identify spatial references is that these particular URI's can be placed on a different revisit schedule than other URI's for parsing by the web indexing spider.

It is to be understood that multiple phase filtering process can include more than simply a two-stage process as discussed above. For instance, an additional stage can be incorporated to include a country designation. Essentially, the first stage would filter a URI referenced document to the specific country. The second stage would be filtering by the state with the third stage filtering by features.

### Scoring Phase

As described above in the Parsing Phase, the web indexing spider is parsing URI documents and flagging features which are present in the spatial lexicography database. The purpose behind flagging is that the URI can now be scored against a specific spatial reference.

### Archive Phase

The Archive Phase is the depository for four pieces of information regarding each specific URI parsed. This information comprises the URI, the spatial reference, the confidence in the parsing technique used to identify the spatial reference, and the score.

Any hyperlinks identified by the spider in each URI would then be put into a URI database if the URI also contained spatial references. In the next cycle, these newly identified URI's are available for parsing by the web indexing spider. If the URI did not have any spatial references, these hyperlinks are ignored. The basic assumption for ignoring these hyperlinks is that they probably do not contain useful information and search time for the spider would be best utilized by searching other URI's. For example, a URI containing an article on chemistry would have no spatial reference. Any hyperlinks from this article would also most likely have no spatial references. Therefore, a spider would be wasting search time parsing these hyperlinks.

### Modified Search Engine

Our search engine works in two short phases. A client application such as a web browser submits a request to our spatial search engine. The request will be in either the form of an HTTP POST or GET request. The request is directed to the controller, which is a component software that directs requests between the various component software elements. These software elements may reside or be distributed in various network locations physically separate from one another. When the controller receives a request from the client application, the controller formulates a request for the spatial reference search component which then queries the spatial lexicography database. By way of example, a client application, i.e. a web browser, may submit a request for Washington, D.C. The controller will receive this request in a particular format, identified by the client application as a zip code, or GPS coordinate, etc. Besides the location, the client application will also supply the search parameter, such as radius from a reference point. The controller formulates the request by checking to see if all required information has been supplied. If the information has not been supplied, the controller returns an error message. If the required information has been presented, the request type and appropriate parameters supplied to the controller are then submitted to the spatial reference search component.

The spatial reference search component will determine whether the requested spatial search type is coordinate, zip code, area code, or place name. For zip code searches, the component will correct any oddly formed zip codes to its standardized format Next, the component will create an ODBC connection to the spatial lexicography database. It will create a SQL query, which returns the coordinates of the zip code for which information has been requested. The supplied radius is then converted into longitude and latitude coordinates which define the bounded area of interest. These extents are compared to the values in the spatial lexicography database to identify records contained within them. If the search is successful, the spatial reference information is returned to the controller.

For coordinate based queries, the same procedure is used without the zip code queries. The coordinates are supplied direct to the spatial reference search component by the controller. For place name queries, the same procedure as used in zip codes is performed, but it is done with place names. Once the query procedure is complete, the results are formed into one of the following formats as requested by the controller, and initially by the client application: extensible markup language (XML), Array, Structure, List (gives place names only). The foregoing list contains formats presently used for electronic data exchange. However, other formats, presently not yet in existence, can be adapted for use with our search engine. The results, properly formatted for receipt by the client application, are then returned to the controller.

In the second phase, the controller passes a request to the topical data retrieval component. This component takes the construct or results created by the spatial reference search component and uses it as the criteria in a query against a topical database. By way of example, a topical database can be anything of interest to the consumer which has already been spatially indexed, or contains natural spatial references such as a telephone directory. Other examples of a topical database can be, but are not limited to: news articles, classified ads, images, photographs, a web index, books, real estate listings, and store locations. First the component establishes an ODBC connection to the topical database. Next, the component executes an SQL query against the data to find records with values containing the spatial references identified by the first phase. Once the query procedure are complete, the results are formed into one of the following formats as requested by the controller: XML, Array, Structure, List (gives place names only). If a palm database (PDB) format was requested, the controller will convert the data to a palm database for download to a handheld device such as a personal digital assistant (PDA). If wireless access was requested, the resulting PDB is sent to an external system which supports SMTP protocol.

The controller can communicate with the spatial search component and topical search components via HTTP thus allowing distributed processing to occur across a network such as the Internet.

The search engine may be applied as a tool for research and education for schools, libraries, colleges, and universities throughout the world. It can fulfill a similar function for companies and organizations as a data mining tool and will complement traditional search engines. In addition to a desktop based implementation, it may be implemented in combination with wireless positioning and display capabilities, enabling its use for school field trips or other travel applications. The primary function in all of these cases would be Internet and Intranet content management/knowledge management applications.

An alternative implementation of the technology is as a business method for accessing information on the world wide web via map interface. This business method allows users to interact with a map and have spatially relevant search criteria be produced rather than having the map simply act as icons for place names organized hierarchically.

The search interface will accept the latitude and longitude of the users selection on the map and perform a spatial search. The search will identify a list of places within a configurable radius around the user's selection point and use all of these locations in a search rather than a predefined category or user supplied character string. The results can be listed by location and ordered by the locations' distance from the user selection point.

### BRIEF DESCRIPTION OF DRAWINGS

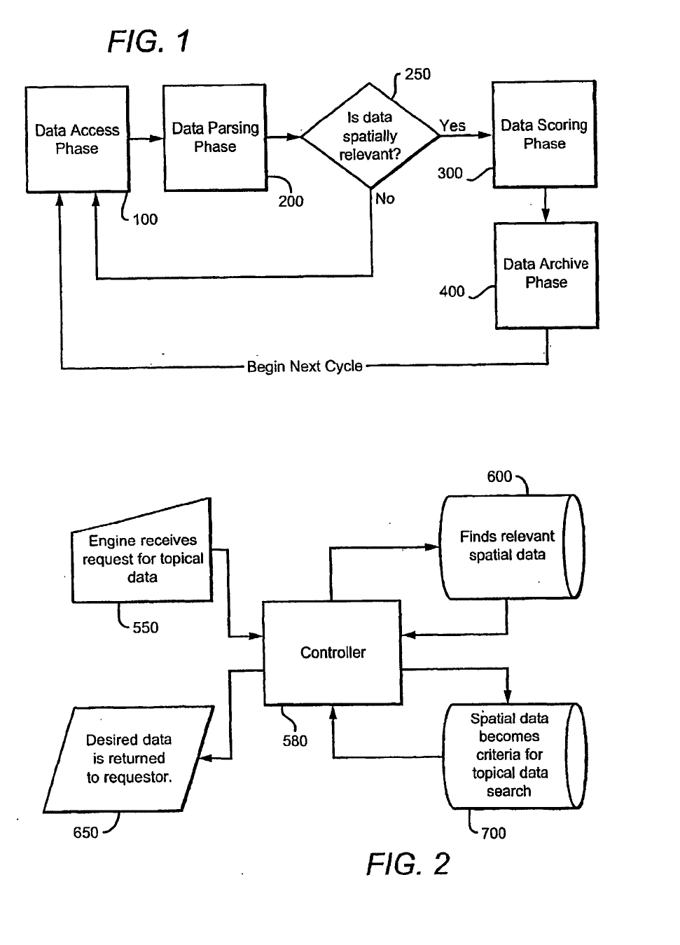

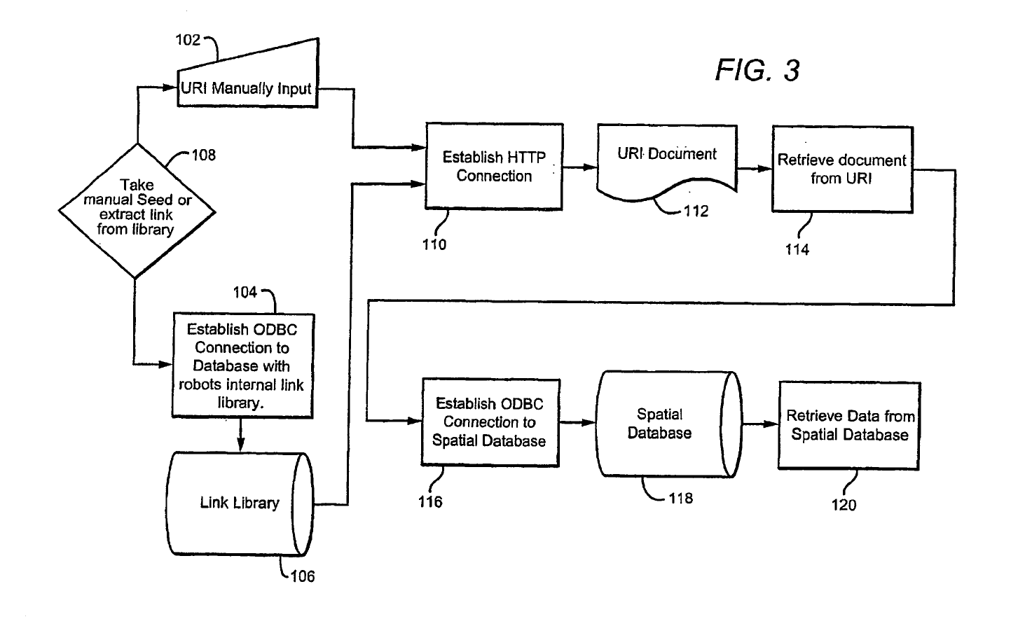

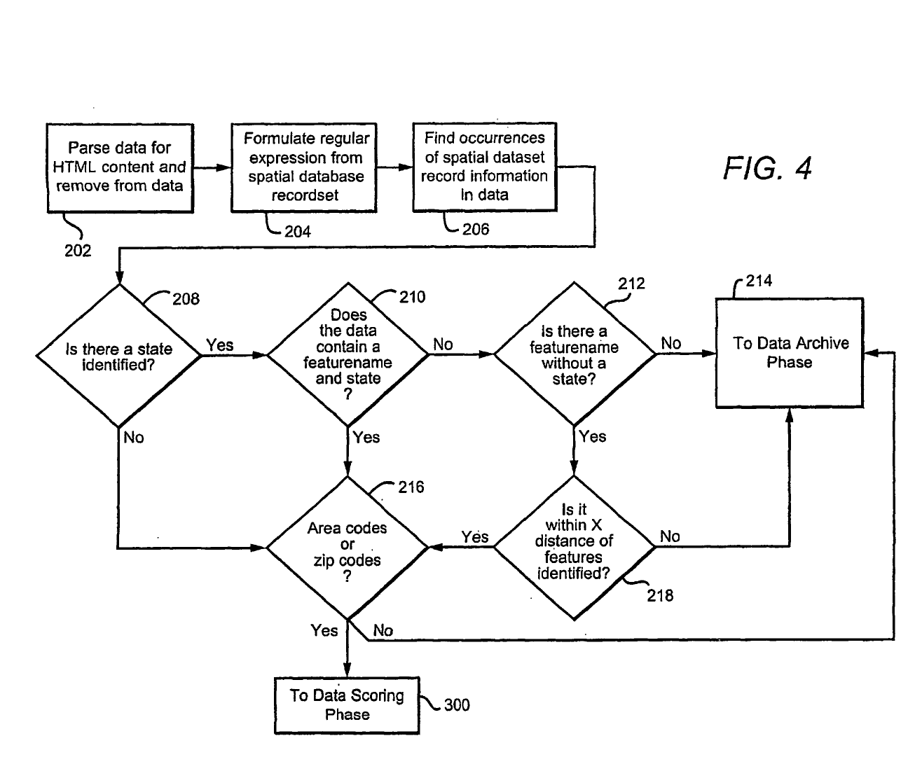

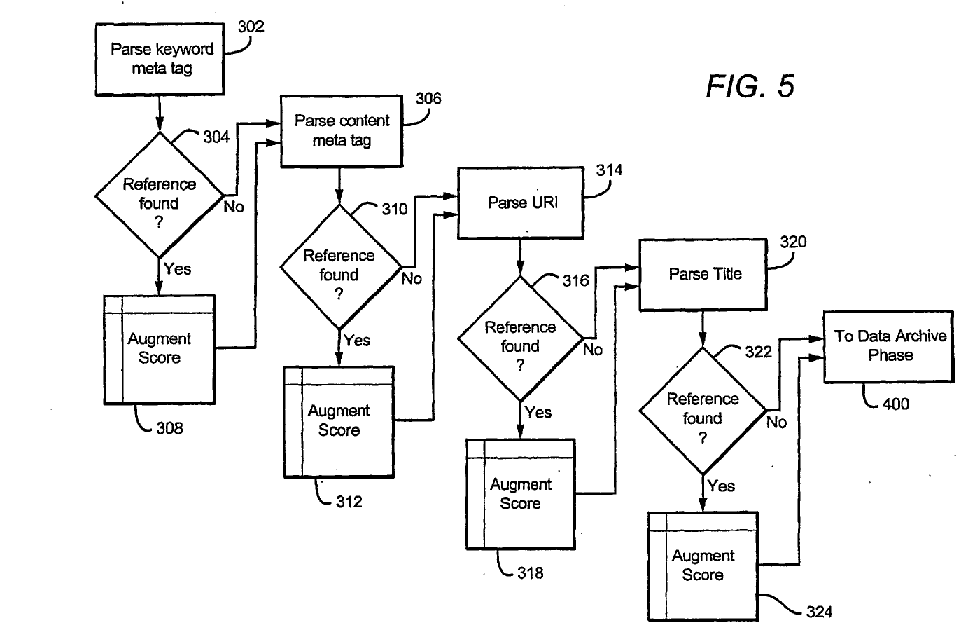

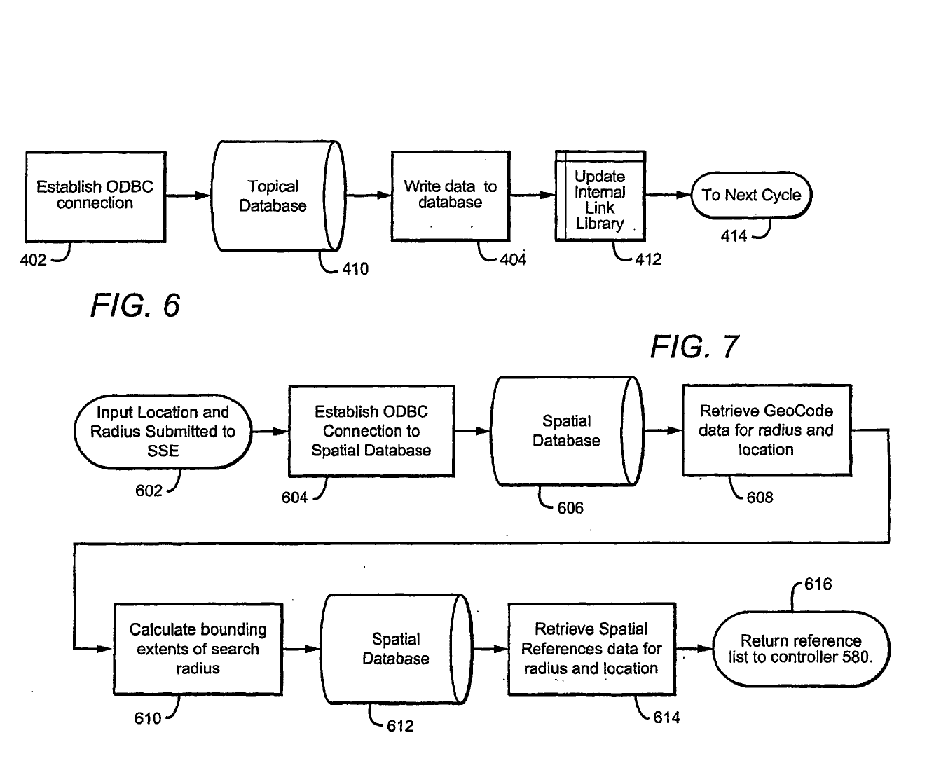

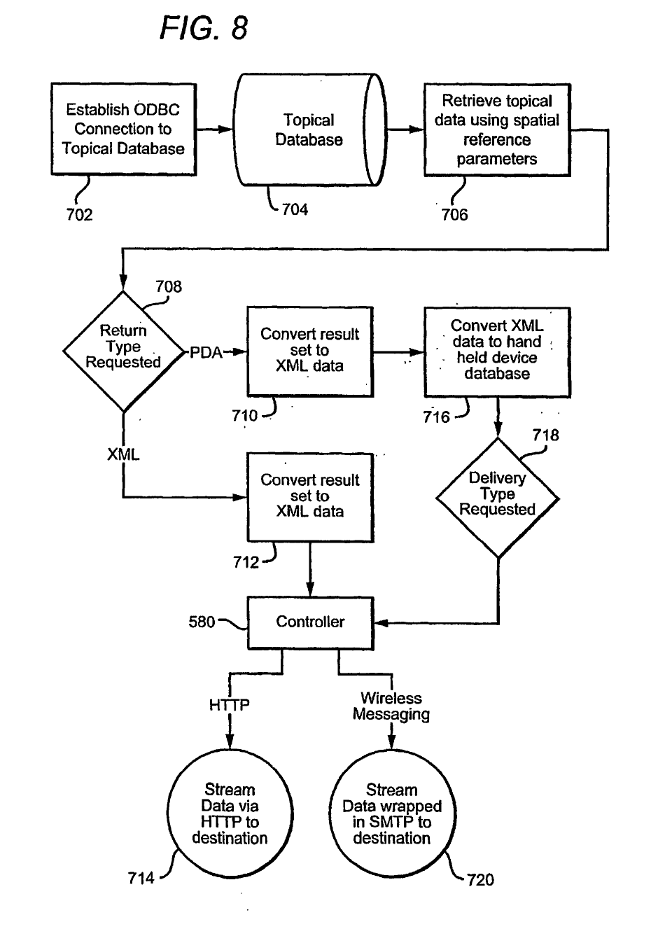

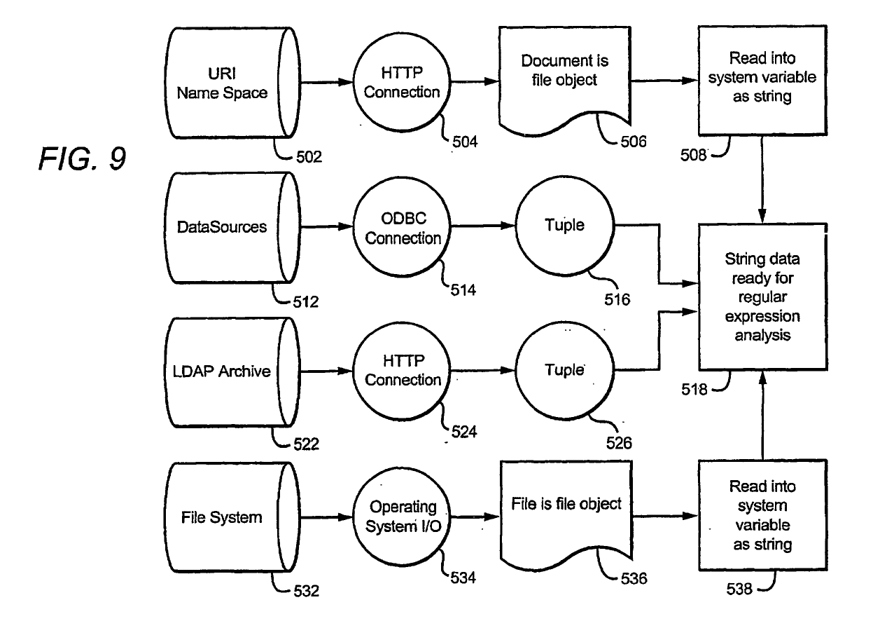

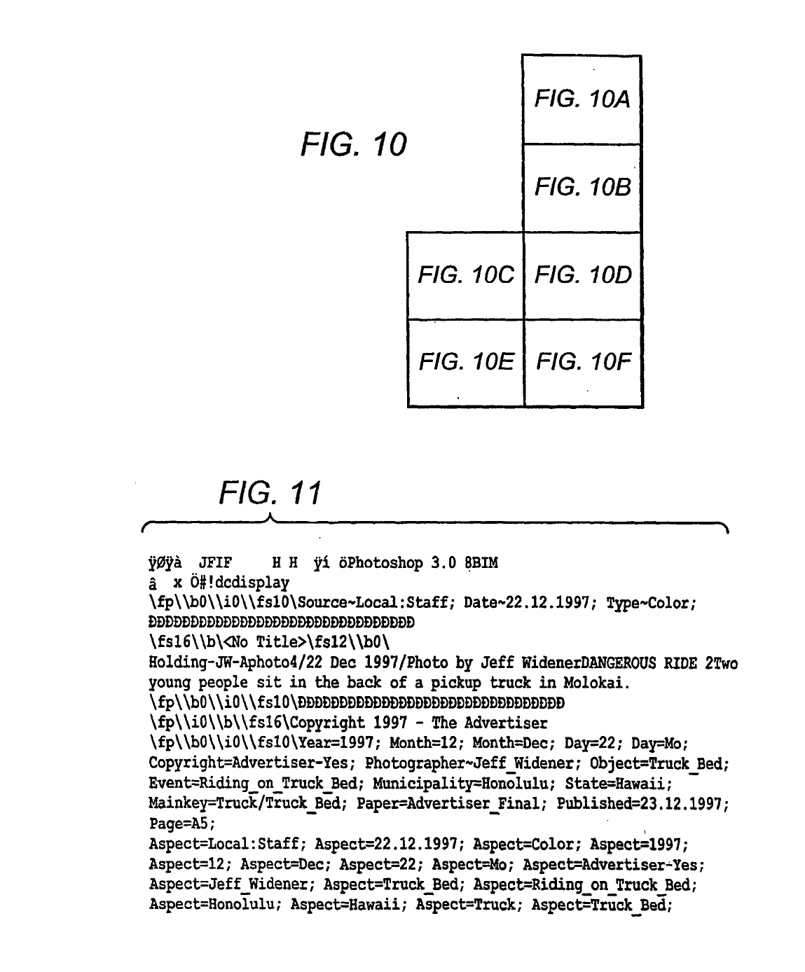

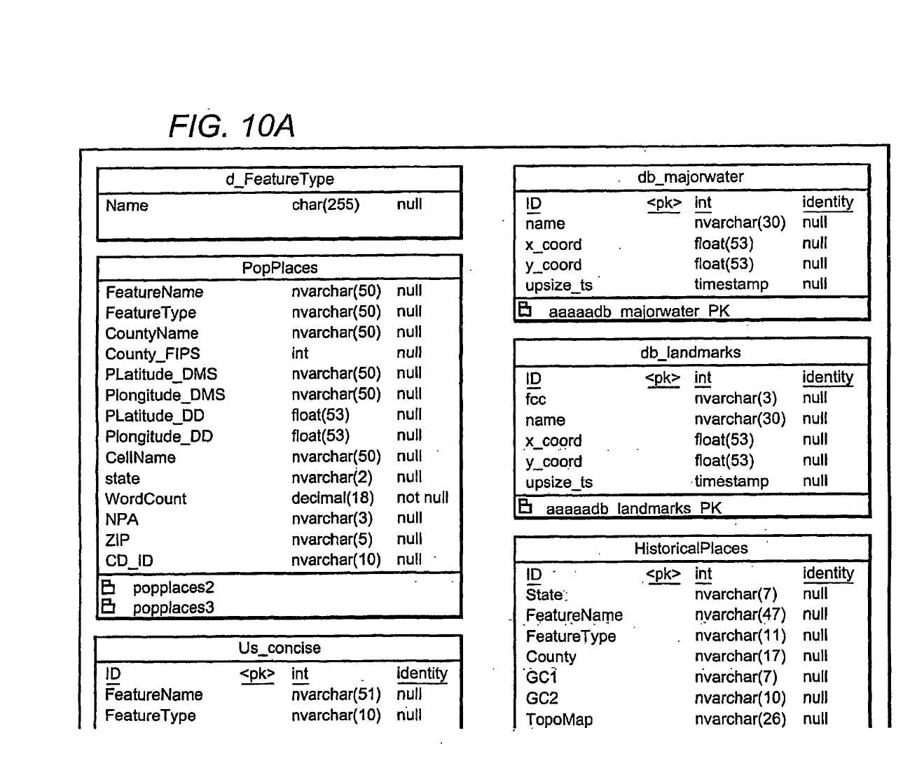

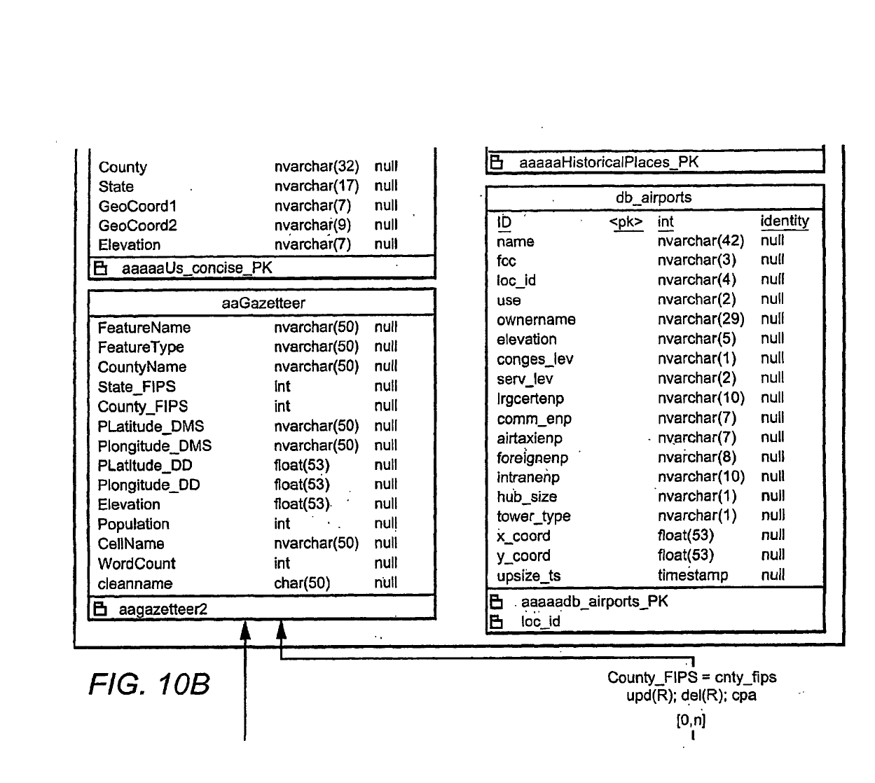

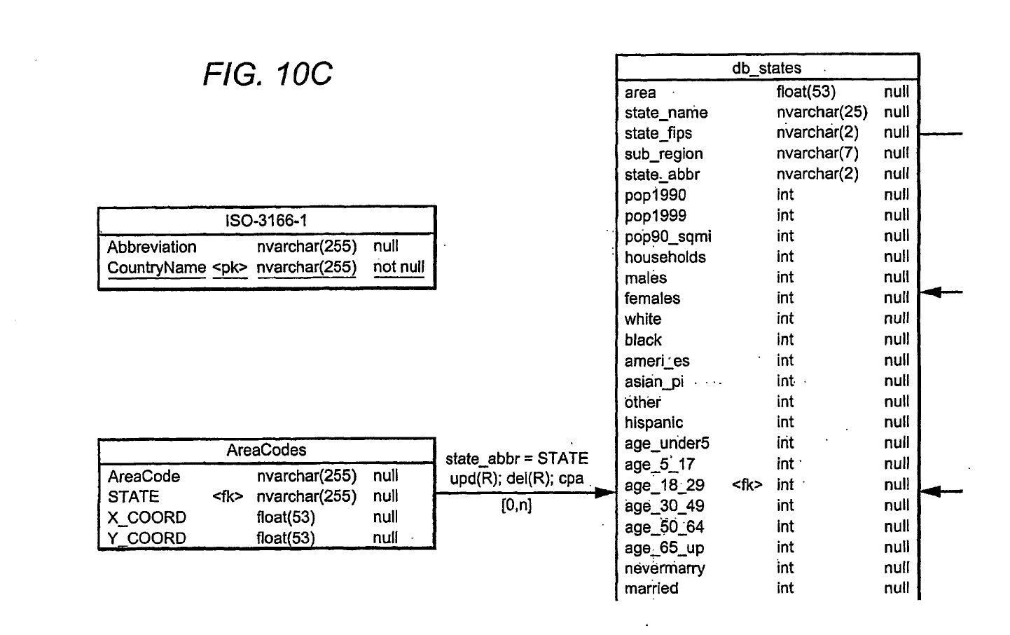

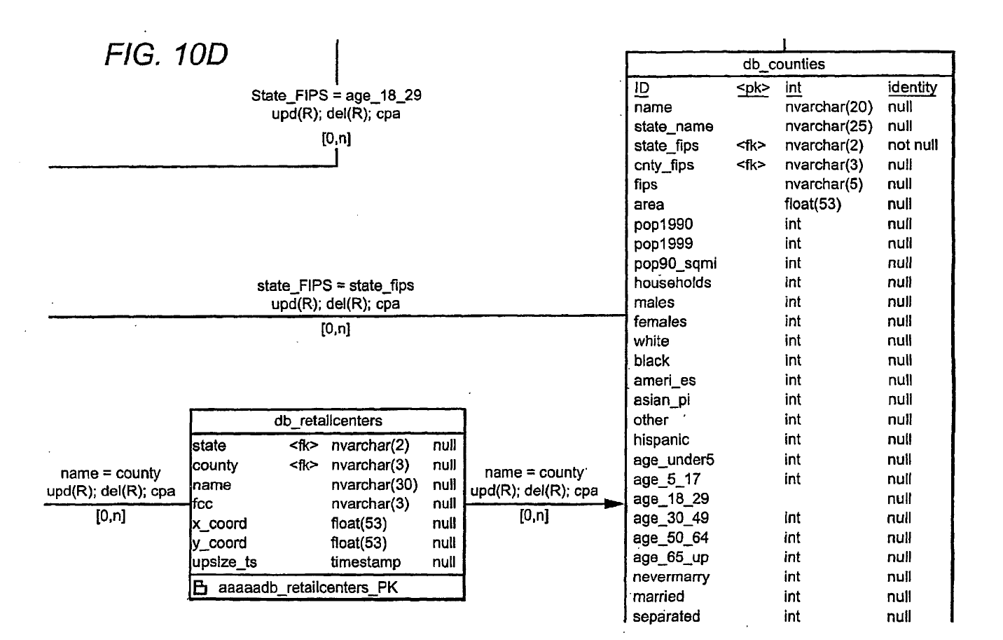

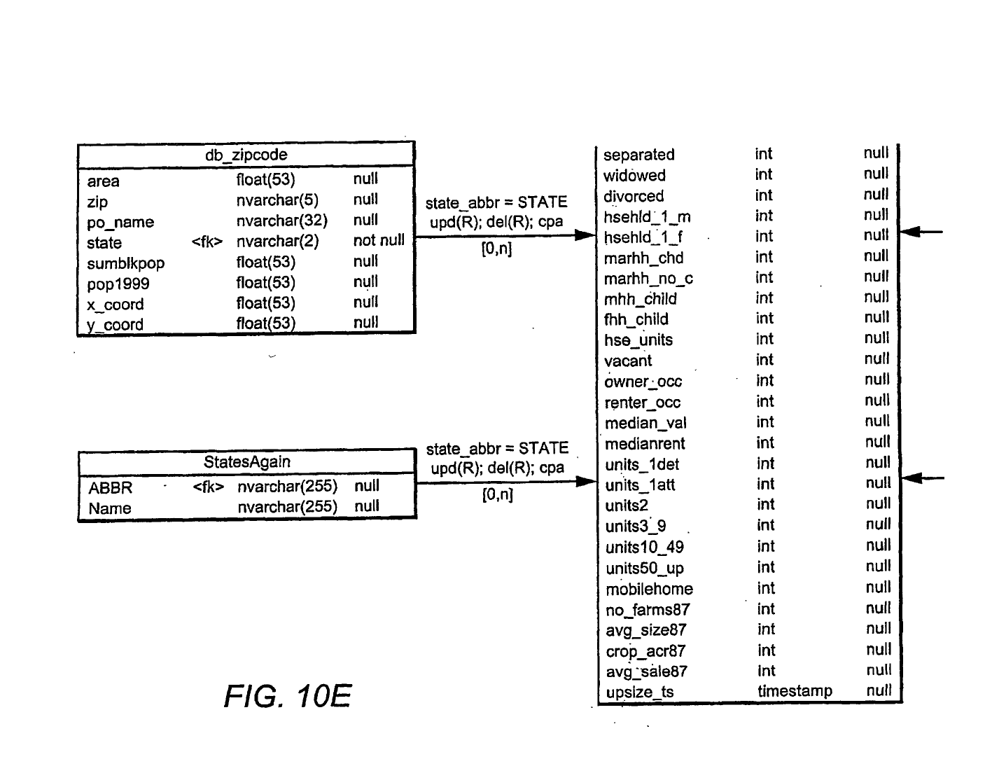

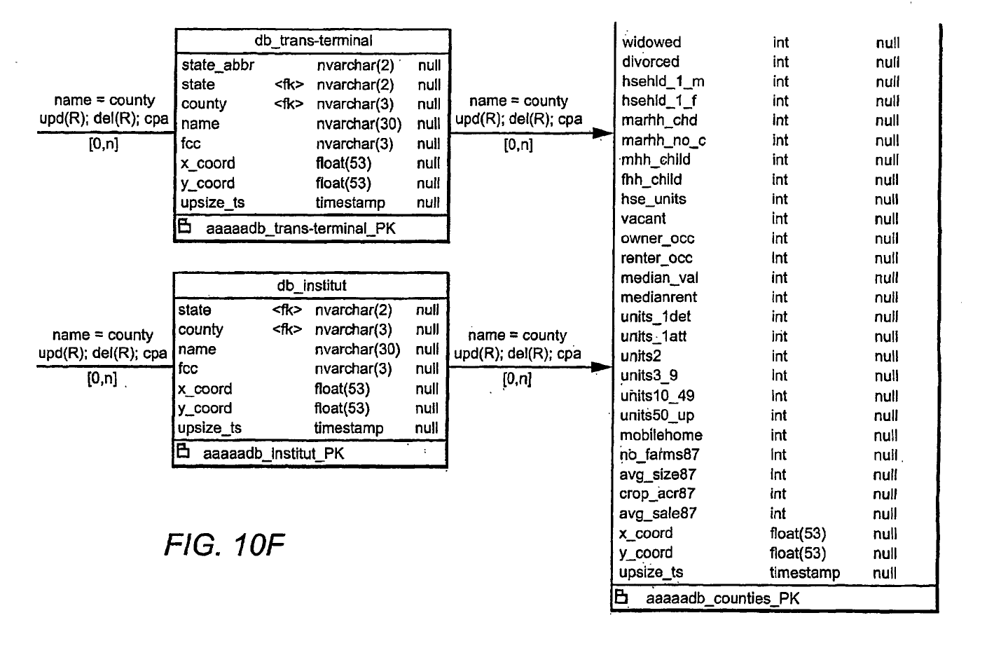

The details of the invention will be described in connection with the accompanying drawings in which FIG. 1 is an overall flowchart for the spatial indexing robot; FIG. 2 is a flowchart for the search engine; FIG. 3 is a flowchart for the Access Phase of the web indexing robot; FIG. 4 is a flowchart for the Parsing Phase of the web indexing robot; FIG. 5 is a flowchart for the Scoring Phase for the web indexing robot; FIG. 6 is a flowchart for the Archiving Phase for the web indexing robot; FIG. 7 is a flowchart for the Spatial Reference Identification Phase for the search engine; FIG. 8 is a flowchart for the Topical Data Retrieval Phase; FIG. 9 a depiction of the types of information available, converted to string data and thereafter used for parsing; FIG. 10 a schema of an example of the spatial lexicography database; FIGS. 10A, 10B, 10C, 10D, 10E and 10F are respective portions of the schema represented in FIG. 10; and, FIG. 11 is an example of a binary stream of data.

### BEST MODE FOR CARRYING OUT THE INVENTION

### Part I:Spatial Indexing Intelligent Agent

As illustrated in FIG. 1, the robot works through phases of activity. The robot begins at the Access Phase 100. Here, the robot obtains three pieces of information: 1) the spatial references from a spatial lexicography database; 2) the input Universal Resource Identifier (URI) which it will process through its current cycle; and, 3) the document which resides at the URI. From there, the robot moves to the Parsing Phase 200 where it processes the document for each possible spatial reference obtained from the spatial lexicography database in block 100. At block 250, the robot decides if the data is spatially relevant; if it is not, the robot returns to block 100 to begin the next cycle. It will do so if no spatially relevant information was identified in block 200. However, if the robot identifies spatially relevant information, it will go on to the Scoring Phase 300 to score the relevance of the spatial references identified during the Parsing Phase 200.

In the Scoring Phase 300, the robot parses the metadata information found in the document which includes the <meta> and <title> HTML tags. There may be multiple occurrences of meta tags in a document. One occurrence may contain a description of the document; a second may contain keywords used to make the document's content key word identifiable. The spider will also parse the URI of the document and the title tag of the document to see if the spatial references it found during Parsing Phase 200 have also occurred in these key portions of the document's structure. The spider will multiply the resulting score from searching these data elements against a factor determined from counting the number of times the spatial reference occurred in the main body of the data. If the number is low, a neutral factor is used; if the number is high, a reducing factor is used and if the number is within normal parameters, an augmenting factor is used. Following the scoring phase, the score and data elements associated with the score proceed to the Archive Phase 400.

In the Archive Phase 400, the robot writes the score and data elements obtained in Scoring Phase 300 into an archival database, logs the URI as either having or not having spatial references, and if spatial references are found, the links from the document are added to the robots internal link library only if the document had spatial references within it. From Archive Phase 400, the robot returns to the Access Phase 100 to begin the cycle again. The Access Phase 100, Parsing Phase 200, Scoring Phase 300 and Archive Phase 400 are each more fully described below.

### Access Phase 100

Access Phase 100 is illustrated in FIG. 3. The robot receives an input Universal Resource Identifier (URI) at block 108 either through manual input at block 102 or by establishing a connection such as Open Database Connectivity (ODBC) to a Relational Database Management Systems (RDBMS) at block 104. If the robot is accessing the RDBMS, it will retrieve a hyperlink stored in link library 106. Link library 106 is a table in the RDBMS filled with hyperlinks gathered by the robot through its indexing process which will be discussed in detail below. Once the hyperlink has been obtained, the robot establishes an HTTP connection to the URI at block 110, retrieves the document indicated at block 112 found at that URI at block 114, establishes a database connection through ODBC at block 116 to the spatial lexicography database at block 118, and retrieves the spatial data set at block 120.

### Parsing Phase 200

In Parsing Phase 200 illustrated in FIG. 4, the spider removes any HTML code from the source document at block 202; formulates a Regular Expression search criteria at block 204 for each record in the spatial lexicography database; parses the contents of the document at block 206 and attempts to match patterns from the regular expression against the document which is now represented as a stream of characters. The spider search technique includes a series of alternative formulations until all forms of the record have been exhausted. By way of example, all of the following variations will be searched for the location “Saint Paul, Minnesota”: “Saint Paul, Minnesota”, “St. Paul, Minnesota”, “Saint Paul, MN”, “St. Paul, MN”, “St Paul, Minnesota”, and “St Paul, MN”.

Blocks, 208, 210, 212 and 216 are subparts of block 206. At block 208, the robot checks the document to identify any occurrences of state names and variations thereof in the document. If no state is identified, processing moves to block 216 where the robot parses the document for the occurrence of zip codes or area codes. Any zip codes or area codes identified become associated with the document as the robot moves into Scoring Phase 300.

If a single state or multiple states are identified at block 208, the robot re-parses the document at block 210 to identify a concatenation of a feature name which is associated with each state name identified in block 208. For example, a feature name can be a city such as St. Paul. If Minnesota is the state identified at 208, the concatenation will be any Minnesota city which is adjacent to Minnesota in the stream of data for a document. Occurrences of city-state concatenation such as in the example “St. Paul Minnesota” will move the robot to block 216. Feature names can be more than simply cities. Examples of other such categories were identified earlier under the heading “Spatial Indexing Intelligent Agent/Data Access Phase”.

If a feature name/state name concatenation is not found, the spider will proceed to block 212. It will then re-parse the document to determine if any feature name exists which is associated with each state identified at 208 but which is not adjacent to the state in the same document.

Spatial coordinates are then obtained for each feature name identified at block 212 within the document which is associated with a state but not a concatenation with the state. The spider, having the spatial coordinates, then calculates the distance between each possible pair of feature name locations. Block 218 is a mathematical algorithm to filter out outlying locations which have a low probability of being associated with the other feature name locations. For example, assume that a document has the following feature name/state name combinations: Arlington, Va.; Crystal City, Va.; Washington, D.C., Bethesda, Md., and Richmond, Va. Next, the spider will determine, based upon the spatial coordinates for each city, that the document has a high probability that it is not about Richmond, Va. The document then is re-parsed for area codes and zip codes at block 216 as described above and the robot moves into Scoring Phase 300.

### Scoring Phase 300

In Scoring Phase 300 illustrated in FIG. 5, the robot parses the document for metadata information such as <meta> and <title> HTML tags which are associated with the spatial references found from Parsing Phase 200. In our example above, these spatial references were cities. At block 302, the robot is parsing the keyword meta tag for the cities identified. Any cities are identified at block 304 and the score is augmented higher. For each piece of meta data, this process is repeated at blocks 306, 314, and 320. A score has now been created for each spatial reference. Therefore, in our example, each of the four remaining cities receives a score. The purpose is to determine how much each city is related to the document.

Following scoring, the spider carries the following information to Archive Phase 400: the document URI, and the feature names, score, and meta data associated with the document.

### Archive Phase 400

In Archive Phase 400 illustrated in FIG. 6, the robot establishes a connection, such as an ODBC connection, at block 402 with a results database 410. The information which the spider carries from Scoring Phase 300 is then written into results database at block 404. The spider next deposits all hyperlinks located in the document into an internal link library 412. The spider then returns to step 104 in Access Phase 100 to obtain a new URI and repeat the cycle for the new document.

### Underlying Database

A postal address database is not used to provide the spatial relevance criteria for our robot as is common with other spatial robots. We have instead developed a spatial lexicography database of spatial language, which includes the names, locations, and supplemental attribute information such as historical facts and demographic statistics about identifiable spatial locations, which may or may not have an address. The data models shown in the following figures illustrate the many fields of information which can be included as part of the spatial lexicography database. FIG. 10 is a schema and FIG. 10A-F are enlarged views of segments of FIG. 10. The relationships in this database provide the capability to perform queries with lexicographical parameters. For example, a person seeking a bed and breakfast inn may use the following query using the spatial lexicography database described as the invention: Display all the results which satisfy the following criteria: a) towns in Nevada having a population of less than 5,000; b) with an average income of greater than $75,000; c) within twelve miles of a river; d) having at least 6 historical features within 6 miles; and e) all towns identified must be within 100 miles of each other. The user is able to query for results which have qualities that the user deems desirable. This is in contrast to present search engines which only provide results within a radius of an initial reference point.

### Data Sources

Our spider is capable of traversing the Internet and performing the role of a web-indexing robot while performing spatial indexing at the same time. Besides traditional databases, our spider can index content found in both binary and textual files, LDAP systems, and document management systems.

This is possible because information is converted to raw data streams regardless of source. As far as the robot is concerned, it simply needs to be instructed to use a specific protocol, such as whether to use its HTTP, ODBC, or file I/O interface and the results are returned as data streams for further processing. The robot does not require potential spatial elements be identified prior to its use such as is the case with robots that need to know which column of a database to index because all of the data is in a specific, single stream as illustrated in FIG. 9. File systems are accessed using a program language such as C's standard input-output (stdio) package and file objects are created. The file object is then opened and read into a large character stream such that the file may be processed the same way as is ODBC and HTTP data.

FIG. 9 illustrates how data is converted to “string” data type for the robot to parse. Block 502 is the URI name space which may be an image, document, data stream, binary object or multimedia application or content. The robot accesses the data identified at Block 502 through a Hyper Text Transfer Protocol (HTTP) at block 504. Regardless of the actual data type retrieved, the data is treated as a file object at block 506. The contents of the file object are read into a system variable at block 508 which means the entire content of the HTTP stream of information is collected as character data using ASCII and Unicode encoding to preserve the data's integrity. This system variable is ready for regular expression parsing at block 518.

If the data was instead coming from an ODBC data source, which includes text files, objects in an Object Relational Database (ORDB), RDBMS data, and certain supported file types, the data source at block 512 would be accessed via an ODBC connection at block 514 and the results of the access are gathered into tuples at block 516. Tuples are pairs of objects and the entire tuple can be cast as a string type regardless of the object pair's native data types. For this reason, the tuples are ready at block 518 for regular expression parsing.

If the data was instead coming from a directory as indicated by block 522, it may be accessed via HTTP wrapped around Local Directory Access Protocol (LDAP) at block 524. HTTP will carry LDAP messages to the directory to access the data. Like ODBC, LDAP data sources are received as tuples at block 526. As above, tuples can be cast as string types and are ready for regular expression parsing at block 518.

If the data resides on a file system indicated as block 532, the operating system is accessed to retrieve the files in block 534. Like an HTTP connection, the data is returned as a file object at block 536 and is read into a system variable as before, in block 538. The system variable is string data type and is ready for regular expression parsing at block 518. The robot's search logic is based on regular expressions, which require the data to be of a string data type. As illustrated in FIG. 9, all data reaches the spider's parsing phase as string type data. A regular expression (RE), i.e. a pattern of characters with wildcards, can represent different string combinations which have the same meaning. This allows the spider to check if a particular string matches a given regular expression or if a given regular expression matches a particular string. Regular expressions can be concatenated to form new regular expressions. For example, if A and B are both regular expressions, then AB is also a regular expression. If a string p matches A and another string q matches B, the string pq will match AB. Thus, complex expressions can easily be constructed from simpler ones.

For example, the spider would find the place name “Molokai” in the binary stream of data illustrated in FIG. 11.

### Results Scoring

There are two types of scoring envisioned by the invention. The first is “All Data Sources” and the second is “HTML”.

For “All Data Sources” type of results scoring, our robot supports both a ‘method employed’ confidence measure and a ‘topical confidence’ score. The ‘method employed’ score indicates the method of spatial reference discovery used in the indexing process. The ‘topical confidence’ score indicates whether the robot determined that the data's topic was the spatial reference or whether the data obtained from the source document or source database record merely mentioned the spatial reference in passing.

Our robot combines many different factors to find the best matches, including text relevance and link analysis. Our robot uses text analysis which searches every data element for variations of spatial references listed in the spatial lexicography database. Variations include occurrence of abbreviations and alternative forms of the name (i.e. Saint, St., San). In addition to text analysis, our robot uses contextual analysis by identifying attribute information from the spatial lexicography database in the text of the document. Contextual analysis may indicate that the word occurrence is indeed the desired name and not a different meaning with the same spelling. This way it can distinguish an occurrence of “Page, Oregon” from a “Web Page”. The robot also considers use of capitalization in its determination of valid spatial references, but this is not a limiting factor in that it can recognize patterns with lower case forms and use this information in its confidence scoring. The robot recognizes that occurrences of portions of a place name may be indicative of a valid spatial reference. The spider will re-index the data to verify if supplementary information from the attributes listed in the spatial lexicography database warrant validation as a spatially relevant data element. In these cases, a lower score is given to its ‘method employed’ score.

The second scoring type, HTML scoring, utilizes elements from the structure of HTML documents to obtain a score. Relevance of the text and contextual occurrence is validated by the occurrence of spatial references in the vicinity of the location believed to be discovered, the occurrence of the spatial reference in key portions of the document such as the title, keywords, Uniform Resource Locator (URL), and description. Multiple occurrences are treated with caution such that low multiples improve confidence while excessive occurrences decrease confidence.

The robot analyzes hyperlinks. Once seed URLs have been provided to the robot, the robot only harvests links from documents that have been successfully indexed with a spatial reference and which also bears a confidence score above a designated threshold. When linked pages are processed which identify the same spatial reference as that of the linking page, and each linked page has a satisfactory score, their confidence is increased as well as the confidence of the source document for that spatial reference. When multiple pages are discovered to be about the same spatial location, the number of pages is checked against a threshold and the entire site is recorded as about the location and individual page references are dropped from the index.

### Spatial Relevance Criteria

Existing robots require postal codes to occur in data for indexing. Our robot can identify occurrences of spatial references that do not have an address such as a stream, park, forest, glen, etc. The robot can correlate discovered spatial locator codes against alternative locator codes or place names to determine the nearest relevant location for the index based on user definable parameters. This technique is used to develop specialized indexes for search engines such as zip code based indexes of data with place names, or coordinate based indexes for data with area codes, etc. The only requirement is the development of a spatial lexicography database with desired spatial references.

Existing spiders index geocentric postal address information. The lack of reliance on postal addresses allows our robot to work with non-geocentric data. Our robot can develop spatial indices for arbitrary mapping systems such as relative positions to a known location as used in CAD drawing of industrial facilities. Our robot can also index against imaginary mapping systems such as those used in role-playing games (RPG). It can also index against other real world coordinate systems such as used in mapping the universe, galaxies, other planets, and moons. The only requirement we have for this is the development of a spatial lexicography database with desired spatial references.

### Part II: Search Engine

Our search engine works in two short phases as illustrated in FIG. 2. A request is made of the search engine at block 550. The controller takes the request at block 580 and initiates a search for relevant spatial references. The search procedure and identified spatial references are indicated generally as block 600. Any results are returned to controller 580. Controller 580 uses the results from the first search as the criteria for the second search. The second search procedure and identified results are indicated generally as block 700. The spatially optimized results are then returned to controller 580. Controller 580 passes any results back to the requestor at block 650. Blocks 600 & 700 are detailed in FIG. 7 and FIG. 8. Controller 580 is simply a switch logic component that passes information through the steps in FIGS. 7 and 8.

Referring to FIG. 7, our search engine takes an input request including a radius and a location as an initial parameter at block 602. A connection is established at block 604 with a spatial lexicography database at block 606 and the requested item is extracted from the database at block 608. The bounding box coordinates of the desired search radius from the location are mathematically calculated at block 610. This calculated bounding box is used as criteria to query the spatial lexicography database at block 612. The results of the second request at block 614 are criteria for querying the topical database in the spatial reference system it uses in the topical retrieval phase identified in FIG. 8.

By way of example, if a user wishes to receive a listing of books about a specific area, the user can provide a zip code and a radius he is interested in searching. Similarly, he could also display an electronic map and zoom to a specific geographic reference and then furnish a radius. The search engine will obtain the latitude and longitude for the zip code or geographic reference from the spatial lexicography database. Next, the search engine will calculate the boundary of the radius in longitude and latitude coordinates. Then the search engine will query the spatial lexicography database for all place names located within the boundary.

Block 616 identifies the relevant spatial data resulting from this search and which are returned to controller 580 for use in the topical query.

The topical data retrieval phase shown in FIG. 8 utilizes the results of the information obtained by the search engine in the spatial reference identification phase. An ODBC connection is established at block 702 with the topical database 704. The spatial reference parameters developed from the spatial reference identification phase 600 is used to extract records that fall within the bounding box of the initial request identified as block 706. At block 708, the engine will determine what return data format is required. The data is converted to an XML messaging format at either block 710 or 712. The XML data is either streamed via HTTP at block 714 via controller 580 to the requester (not shown) or alternatively, the data is converted to a handheld database at block 716. If a hand held device database is requested at block 718, the handheld database is either streamed over HTTP at block 714 via controller 580 to the requestor (not shown) or sent by e-mail using a wireless protocol at block 720 via controller 580 to the requester (not shown) for wireless retrieval.

In the example above, the search engine in the spatial reference identification phase 600 will finally query a book database for all books having the place names occurring in their title or description. The list of books is then available to the user.

Our search engine searches a spatial lexicography database rather than an index of words or a spatial index collected and/or developed by web indexing robots. The flowchart shown in FIG. 2 illustrates that in the first phase the search engine consults a spatial lexicography database. Results from this phase are communicated via controller 580 to the topical data retrieval phase 700 shown in FIG. 8 where the topical database is searched for matches with the criteria identified in the first phase. The topical data is not required to be pre-indexed (commonly called “geocoding”). Instead, the spatial lexicography database is first consulted for search criteria to be used in the topical database such as a list of place names, zip codes, area codes, etc. Our search engine will then select the records from the topical database that are relevant to the spatial locations gleaned from the spatial lexicography database. Our search engine will further refine its selection by performing text analysis to identify specific items of interest.

Traditional search engines will look for a location of interest by matching the location name with occurrences in a topical database. For example, searching for information about Ojai, Calif. will return topical data that only had Ojai Calif. in the data record. The importance of the spatial data identification phase is that a search “within a five mile radius of Ojai Calif.” will return topical data not only about Ojai but also include surrounding communities even though the user was unaware of these other communities. For example, a search on Ojai will return information about Ojai, Mirarnonte, Miners Oaks, etc. The functionality of this search engine is important in that it can allow a user to locate points of interest not only within a specific city, but will also identify for the user other points of interest which are located within a specified distance which may or may not be within the city limits.

### Non-Postal Spatial Reference Support

A spatial lexicography database model is illustrated in FIG. 10. This database includes identifier information and coordinate information. Optionally, the database can also include attribute information such as historical facts and demographic statistics about identifiable spatial locations. These need not be geographic places and could be galactic, interplanetary, stellar, virtual, arbitrary, or man made spatial definitions (i.e. star maps, imaginary worlds, facilities and building blueprints, and three dimensional spaces could be handled by our search engine and would be candidates for inclusion in the database). Inquiries into the spatial lexicography database may be based on various spatial location identifiers such as coordinates, zip codes, area codes, etc. or non-spatial search parameters (i.e. attribute information) such as demographic parameters (i.e. all towns with populations less than 3,000). These search parameters are not possible with conventional search engines because they rely on an index of postal addresses or phone numbers relevant to the data.

### Alternative Topical Data Sources

Our search engine is not limited to databases created by web-indexing robots and may investigate databases built from relational database management systems, Lightweight Directory Access Protocol, Document Management Systems, Object Relational Database Management Systems, file systems and other data repositories capable of being searched by an indexing agent or bearing direct spatial references internally, for example, image files with embedded headers indicating the place the image originated. FIG. 7 entitled “Spatial Reference Identification Phase” illustrates that the spatial lexicography database is consulted first to develop a criteria set for use in querying the topical database. As in the case of the SRS, our search engine will access any data source reachable via the POP3, HTTP, ODBC, OLE DB, LDAP (HTTP), or file I/O protocols.

### Distributed Transaction Processing

The topical database and spatial lexicography database used in the process may be geographically segregated from each other and the software component can communicate via the HTTP protocol over the Internet to complete the transaction. The HTTP client/server may be HTTP capable software application including a web server, database server, etc.

### Handheld Device Wireless Access and Data Export

Topical databases can be downloaded for offline viewing on hand held devices. The data is dynamically obtained from server databases, converted to hand held device databases, and placed on the hand held device via messaging technologies for wireless access or through HTTP downloads of the database. Results may be edited and synchronized with the server through messaging or HTTP upload mechanisms

We claim;

1. A search method for identifying spatially relevant information in proximity to a reference location comprising the steps of:
providing a spatial lexicography database containing locations which define the searchable universe, said database comprising: a) coordinate information; and, b) identifier information;
providing a second database which contains spatial information;
providing a search criteria comprising a reference location and a search radius about said reference location;
converting said reference location into a three dimensional coordinate;
thereafter, converting said search radius into a coordinate box surrounding said reference coordinate which sets the outer boundary for selecting identifier information;
selecting all identifier information from the spatial lexicography database which fall within the coordinate box; and
comparing the spatial information of said second database against the selected identifier information where matches of information from both databases identify spatially relevant information.

2. The search method of claim 1 wherein the spatial lexicography database further comprises attribute information associated with any of said locations; and,
said search criteria further comprises the use of numerical and character string value parameters for comparison against said attribute information for further refining the selection of identifier information.

3. A spatial lexicography database for resolving different ways of identifying locations to one another, said database comprising:
a. a coordinate system selected from the group comprising: arbitrary, geocentric, virtual, and galactic;
b. identifier information; and
c. attribute information.

4. A spider for parsing resources identified by web addresses located on the internet wherein the improvement comprises:
accepting a resource for deposit into a topical database only if the resource contains spatial information; and, where said resource is thereafter indexed against a spatial lexicography database by identifier information.

5. The spider of claim 4 where the spider only searches a web resource if it obtained the web address of said resource from a previous resource containing spatial information.

6. A spider for parsing non-web data repositories comprising:
accepting a resource for deposit into a topical database only if the resource contains spatial information; and, where said resource is thereafter indexed against a spatial lexicography database by identifier information.
